(19) United States
(12) Patent Application Publication
(10) Pub. No.: US 2009/0034987 A1
(43) Pub. Date: Feb. 5, 2009

(54) WIDEBAND ELECTRIC SIGNAL MIXER AND OPTICAL TRANSMITTER USING THE SAME

(75) Inventors: Sae Kyoung KANG, Daejeon (KR); Je Soo Ko, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics & Telecommunications Research Institute, Daejeon (KR)

(21) Appl. No.: 12/138,881

(22) Filed: Jun. 13, 2008

(30) Foreign Application Priority Data
Aug. 3, 2007 (KR) 2007-0078192

(51) Int. Cl. H04B 10/04; G06G 7/14

(52) U.S. Cl. 398/182; 327/361

(57) ABSTRACT

There are provided a wideband electric signal mixer capable of mixing two inputted electric signals having a wideband frequency spectrum. The wideband electric signal mixer includes an input terminal controlling an input interface and a phase of a differential signal of a first electric signal and a second electric signal, having a wideband spectrum; a signal mixing terminal comprising a transmission gate switch receiving and outputting the second electric signal and mixing the first electric signal with the second electric signal by turning the transmission gate switch on and off using the differential signal of the first electric signal passing through the input terminal; and an output terminal providing an output interface between a mixing signal outputted from the signal mixing terminal and an external circuit unit and amplification function of the mixing signal.

### CROSS-REFERENCE TO RELATED APPLICATIONS

This application claims the priority of Korean Patent Application No. 2007-0078192 filed on Aug. 3, 2007, in the Korean Intellectual Property Office, the disclosure of which is incorporated herein by reference.

### BACKGROUND OF THE INVENTION

1. Field of the Invention

The present invention relates to a wideband signal mixer capable of mixing electric signals having a wideband spectrum and an optical transmitter converting a non return-to-zero (NRZ) signal into one of a return-to-zero (RZ) signal and a carrier suppressed return-to-zero (CSRZ) signal.

The present invention was supported by the IT R&D program of MIC/IITA [2006-S-060-02, OTH-based 40G multi-service transmission technology].

2. Description of the Related Art

Recently, to increase a transmission amount in an optical transmission network, a transmission speed for each channel becomes increased and a gap between channels becomes decreased. Accordingly, it is required to research other optical modulation methods in addition to a non return-to-zero (NRZ) method. Particularly, since an NRZ signal is vulnerable to a nonlinear phenomenon of optical fibers at a transmission system with 40 Gbps for each channel, there have been performed researches on other modulation methods capable of solving this. Accordingly, there are provided a return-to-zero (RZ) method and a carrier suppressed return-to-zero (CSRZ) method as other modulation methods.

In the RZ modulation method, different from the NRZ modulation method, a signal pulse transmitting a signal of “1” is allowed to be present only in a portion of a bit period. Since a bandwidth of the signal is wider than that of the NRZ method, the RZ method is advantageous at high speed transmission. In the CSRZ modulation method, a carrier wave that does not make contributions in information transmission in a power spectrum of RZ is removed, thereby obtaining a transmission power gain.

Conventional optical transmitters of the RZ modulation method and the CSRZ modulation method, as shown in FIGS. 1A and 1B, are embodied using two Mach-Zehnder modulators.

Referring to FIG. 1A, the conventional RZ modulation optical transmitter simply converts a continuous wave (CW) signal 11 into an NRZ signal by using a first Mach-Zehnder modulator 12, modulates an output signal of the first Mach-Zehnder modulator 12 at a frequency of 40 GHz identical to a data transmission rate while setting a bias voltage of a second Mach-Zehnder modulator 13 to be on an intermediate point of a transfer characteristic curve, and generates an RZ optical signal by generating a pulse signal within a bit period.

Referring to FIG. 1B, the conventional CSRZ modulation optical transmitter simply converts a CW signal 21 into an NRZ signal by using a first Mach-Zehnder modulator 22, modulates an output signal of the first Mach-Zehnder modulator 22 with a frequency of ½ of a data transmission rate, that is, 20 GHz while setting a bias voltage of a second Mach-Zehnder modulator 23 to be on a null point of a transfer characteristic curve, and generates a CSRZ optical signal. That is, since the bias voltage of the second Mach-Zehnder modulator 23 is set on the null point of the transfer characteristic curve, the CSRZ optical signal is generated while a phase of an output waveform is changed by 180 degrees for each bit period.

However, as described above, when generating an RZ signal or a CSRZ signal, two Mach-Zehnder modulators are used, different from the case of using an NRZ signal.

When configuring such optical transmitter employing one of the RZ modulation method and the CSRZ modulation method, to reducing the number of Mach-Zehnder modulators, there is required an apparatus capable of mixing two electric signals having a wideband frequency spectrum.

However, a conventional electric signal mixer as shown in FIG. 2 is for mixing a radio frequency (RF) signal with a local oscillator (LO) signal generated by an oscillator 130 to be converted into a signal having a lower frequency, employs a field-effect transistor (FET) as a mixing unit 110, and mixes the RF signal with the LO signal or an intermediate frequency (IF) signal with the LO signal using voltage switch characteristics of the mixing unit 110.

However, the electric signal mixer is just for a narrowband RF signal, which cannot used as a mixer for a signal having a wide spectrum, such as an NRZ data signal or a clock signal.

### SUMMARY OF THE INVENTION

An aspect of the present invention provides wideband electric signal mixer capable of mixing two inputted electric signals having a wideband frequency spectrum, being miniaturized, and being manufactured at a low price and an optical transmitter using the wideband electric signal mixer.

According to an aspect of the present invention, there is provided a wideband electric signal mixer including: an input terminal controlling an input interface and a phase of a differential signal of a first electric signal and a second electric signal, having a wideband spectrum; a signal mixing terminal comprising a transmission gate switch receiving and outputting the second electric signal and mixing the first electric signal with the second electric signal by turning the transmission gate switch on and off using the differential signal of the first electric signal passing through the input terminal; and an output terminal providing an output interface between a mixing signal outputted from the signal mixing terminal and an external circuit unit and amplification function of the mixing signal.

The signal mixing terminal may include: first and second inverters receiving the differential signal of the first electric signal, respectively, and controlling the differential signals to have the same phase; a third inverter receiving the clock signal and executing a push-pull function of the clock signal; the transmission gate switch turned on and off by the differential signals of the first and second electric signal transferred from the first and second inverters, outputting the clock signal transferred from the third inverter when turned on, and outputting “0” signal when turned off; a fourth inverter transferring an output signal of the transmission gate switch to the output terminal.

According to another aspect of the present invention, there is provided an optical transmitter including: a wideband electric signal mixer comprising a transmission gate switch transferring a clock signal with a certain frequency, turning the transmission gate switch on and off using a differential signal of a data signal to be transmitted, mixing the clock signal with the data signal to output an electric signal with three levels; a light source emitting continuous light; and a Mach-Zehnder modulator driven by the electric signal with three levels outputted from the wideband electric signal mixer and converting the light emitted from the light source into an optical signal.

As described above, the wideband electric signal mixer may mix two electric signals having a wideband spectrum and be miniaturized and manufactured at a low price since the elements thereof are capable of being embodied as one electronic integrated circuit. Also, the optical transmitter may reduce the size and manufacturing costs thereof by employing the wideband electric signal mixer capable of being miniaturized and manufactured at a low price.

### BRIEF DESCRIPTION OF THE DRAWINGS

The above and other aspects, features and other advantages of the present invention will be more clearly understood from the following detailed description taken in conjunction with the accompanying drawings, in which:

FIG. 1A is a block diagram illustrating a conventional return-to-zero (RZ) optical transmitter;

FIG. 1B is a block diagram illustrating a conventional carrier suppressed return-to-zero (CSRZ) optical transmitter;

FIG. 2 is a block diagram illustrating a conventional electric signal mixer;

FIG. 3 is a block diagram illustrating a wideband electric signal mixer according to an exemplary embodiment of the present invention;

FIG. 4 is a detailed circuit diagram illustrating the wideband electric signal mixer of FIG. 3;

FIG. 5 is a detailed circuit diagram illustrating a transmission gate switch included in the wideband electric signal mixer of FIG. 3;

FIGS. 6A to 6D are timing diagrams illustrating operation of the wideband electric signal mixer of FIG. 3; and

FIG. 7 is a block diagram illustrating a CSRZ optical transmitter including the wideband electric signal mixer.

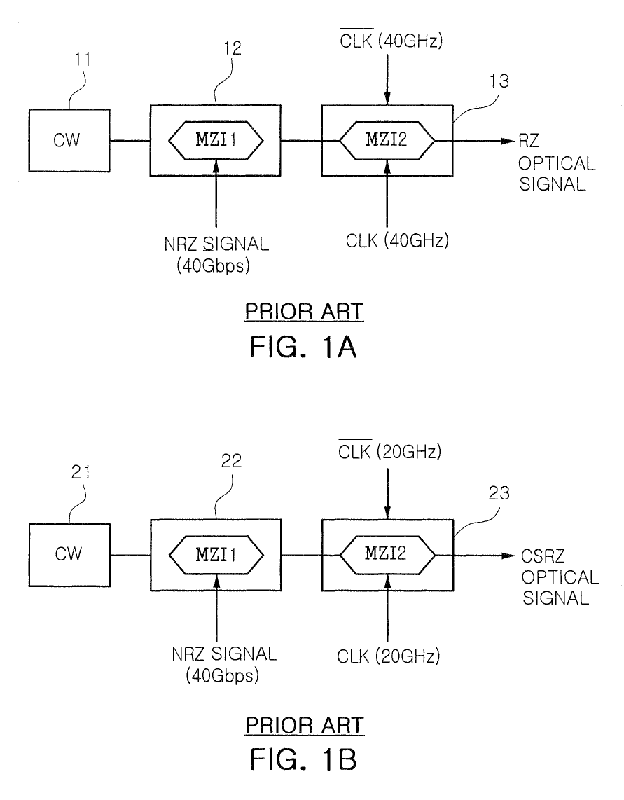

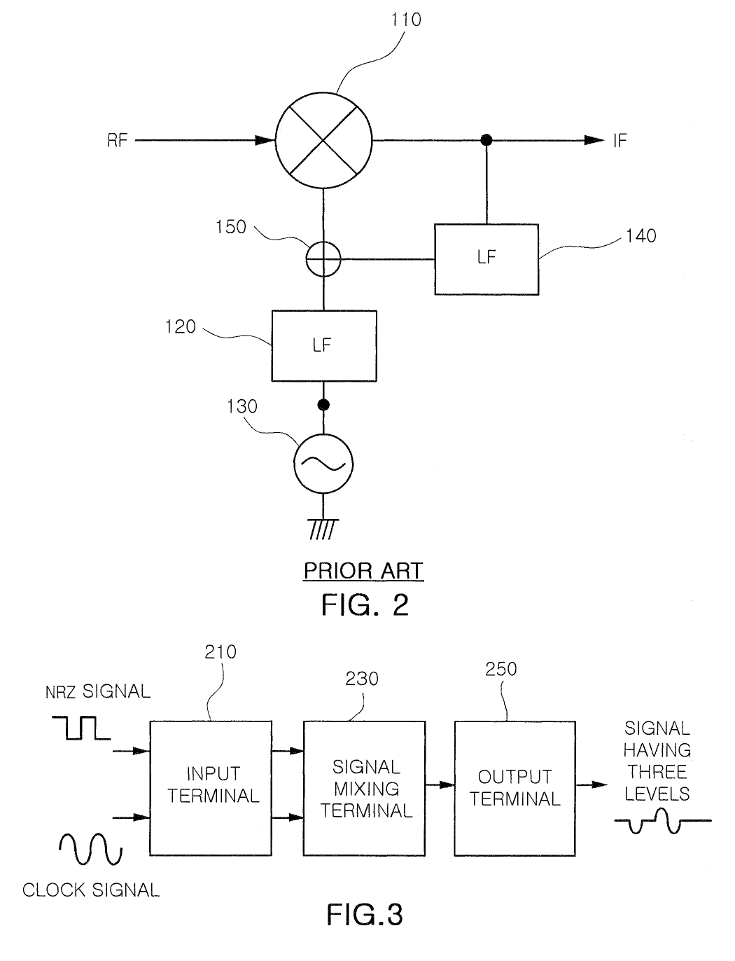

### DETAILED DESCRIPTION OF THE PREFERRED EMBODIMENT

Exemplary embodiments of the present invention will now be described in detail with reference to the accompanying drawings. Only, in describing operations of the exemplary embodiments in detail, when it is considered that a detailed description on related well-known functions or constitutions may make essential points of the present invention be unclear, the detailed description will be omitted.

In the drawings, the same reference numerals are used throughout to designate the same or similar components.

Throughout the specification, when it is describe that a part is “connected to” another part, this includes not only a case of “being directly connected to” but also a case of “being indirectly connected to”, interposing another device therebetween. Also, when it is described that an apparatus “includes” an element and there is no opposite description thereof, this is not designate that the apparatus excludes other elements but designates that the apparatus may further include other elements.

FIG. 3 is a block diagram illustrating a wideband electric signal mixer according to an exemplary embodiment of the present invention.

Referring to FIG. 3, the wideband electric signal mixer includes an input terminal 210 controlling an interface and a phase of first and second electric signals having a wideband spectrum, which will be mixed, a signal mixing terminal 230 mixing the first and second electric signals by switching the second electric signal according to the first electric signal transferred via the input terminal 210, and an output terminal 250 providing a signal interface between the signal mixed by the signal mixing terminal 230 and an external circuit unit and an additional amplitude gain.

In this case, the first and second electric signals are signals having a wide frequency spectrum, for example, may be a non return-to-zero (NRZ) signal and a clock signal.

That is, the input terminal 210 receives the first and second electric signals, controls phases thereof, and transfers the first and second signals with controlled phase to the signal mixing terminal 230. The signal mixing terminal 230 is switched by the transferred first and second signals and mixes the first and second electric signals. The mixed signal is transferred to another external circuit via the output terminal 250.

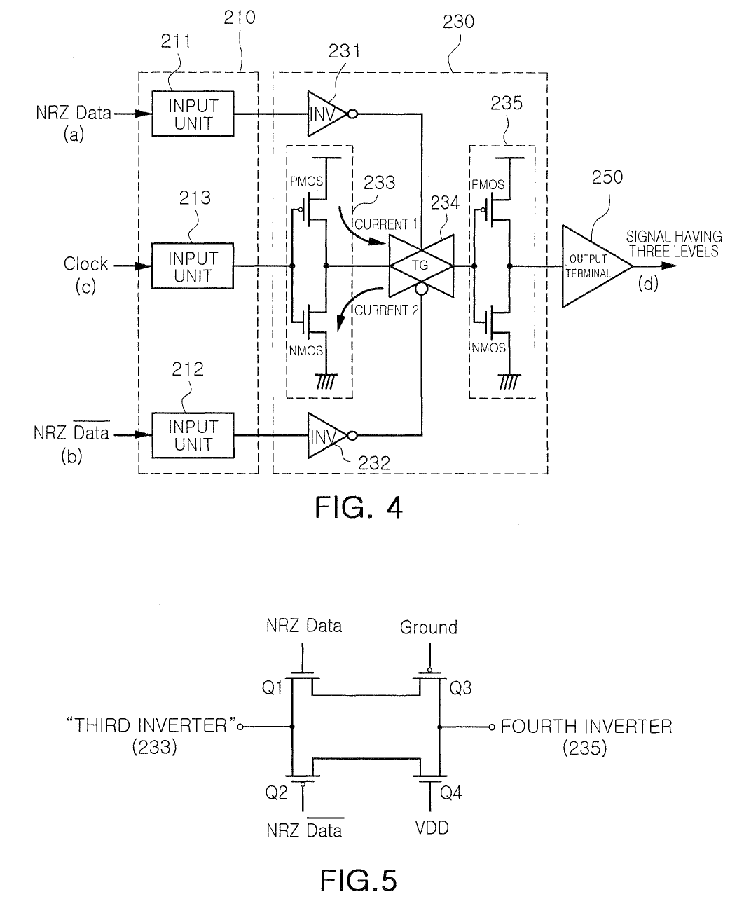

A detailed configuration and operation of the wideband electric signal mixer may be easily understood with reference to FIG. 4. Hereinafter, the first electric signal and the second electric signal are assumed as an NRZ data signal and a clock signal, to be transferred using a return-to-zero (RZ) method and a carrier suppressed return-to-zero (CSRZ) method, respectively. However, the present invention is not limited thereto. It is possible to use any electric signal having a wideband spectrum, such as the NRZ data signal and the clock signal.

FIG. 4 is a detailed circuit diagram illustrating the wideband electric signal mixer of FIG. 3. A detailed configuration and operation of the wideband electric signal mixer will be described with reference to FIG. 4.

Referring to FIG. 4, the input terminal 210 includes first and second input units 211 and 212 for receiving a differential signal of the NRZ data signal (hereinafter, referred to as an NRZ differential signal) that is the first electric signal, respectively, and a third input unit 213 for receiving the clock signal that is the second electric signal. The first to third input units 211 to 213 include a block for compatibilities of electric signal interfaces of an input signal and a block capable of controlling a phase between the two signals and execute the interface compatibility and phase control with respect to the NRZ differential signal and the clock signal.

The NRZ differential signals and the clock signal transferred via the first to third input units 211 to 213 are inputted to the signal mixing terminal 230. The signal mixing terminal 230 electrically mix the two signals by switching the clock signal according to the NRZ differential signal by using a transmission gate switch and converts the two signals into a signal having three levels. For this, the signal mixing terminal 230 includes first and second inverters 231 and 232 receiving the NRZ differential signal, respectively, a third inverter 233 receiving the clock signal, a transmission gate (TG) switch 234 turned on and off according to signals of the first and second inverters 231 and 232 and selectively outputting a signal inputted from the third inverter 233, and a fourth inverter 235 receiving an output signal of the TG switch 234.

In this configuration, a TG switch is generally formed of a pair of n-type metal-oxide semiconductor (NMOS) transistor and a p-type metal-oxide semiconductor (PMOS) transistor, is switched on and off according to a differential signal inputted to the gate, and transfers the inputted differential signal to the output terminal as it is. Due to an NMOS transistor having excellent transfer characteristics with respect to a signal “0” and a PMOS transistor having excellent transfer characteristics with respect to a signal “1”, an input formed of “0” and “1” is well transferred.

The embodiment of the present invention employs such TG switch. FIG. 5 is a circuit diagram illustrating a detailed configuration of the TG switch 234 included in the wideband electric signal mixer according to the present embodiment.

Referring to FIG. 5, the TG switch 234 is formed of a first pair of NMOS and PMOS transistors Q1 and Q2 switched on and off according to the NRZ differential signal and transferring an output of the third inverter 233 as it is when switched on and a second pair of NMOS and PMOS transistors Q3 and Q4 always switched on and outputting an output signal of the first pair of NMOS and PMOS transistors Q1 and Q2 to the fourth inverter 235.

In detail, when an output electric potential of the third inverter 233 is lower than that of the fourth inverter 235, a source of the first NMOS transistor Q1 is connected to a drain of the first PMOS transistor Q2 and a drain of the first NMOS transistor Q1 is connected to a source of the second NMOS transistor Q3, a source of the first PMOS transistor Q2 is connected to a drain of the second PMOS transistor Q4, and a drain of the second NMOS transistor Q3 is connected to a source of the second PMOS transistor Q4.

In the case, an NRZ signal, that is, NRZ data is applied to a gate of the first NMOS transistor Q1, an inverse NRZ signal is applied to a gate of the first PMOS transistor Q2, a gate of the second NMOS transistor Q3 is connected to a power supply VDD, and a gate of the second PMOS transistor Q4 is connected to a ground.

Accordingly, the first pair of NMOS and PMOS transistors Q1 and Q2 is switched on and off according to the NRZ signal and the second pair of NMOS and PMOS transistors Q3 and Q4 is always switched on.

A general TG switch is formed of one pair of NMOS and PMOS transistors. If the general TG switch is applied to the present embodiment, though the TG switch is turned off, it is impossible to maintain a state in which an output signal is “0”, due to a clock signal always transferred to an input side.

However, in the present embodiment, as shown in FIG. 5, the TG switch 234 is formed of the first and second pairs of NMOS and PMOS transistors Q1, Q2, Q3, and Q4 and the second pair of NMOS and PMOS transistors Q3 and Q4 are always turned on, thereby reducing the effect of the clock signal on the output signal of the TG switch 234 when the TG switch 234 is turned off.

Referring to FIG. 4, the output terminal 250 is allowed to have an electric signal interface function with an external circuit and additional amplitude gains to transfer a mixed signal having three levels, outputted from the signal mixing terminal 230, to the external circuit, without loss or distortion.

The input terminal 210, the signal mixing terminal 230, and the output terminal 250 may be embodied as one electronic circuit chip.

Operation of the wideband electric signal mixer is as follows.

The first and second input units 211 and 212 of the input terminal 210 receive differential signals of a first electric signal, that is, NRZ differential signals NRZ DATA and NRZ D̅A̅T̅A̅, respectively, and controls an input interface and phase of the NRZ differential signals NRZ DATA and NRZ D̅A̅T̅A̅. The third input unit 213 of the input terminal 210 controls an input interface and phase of a clock signal and transfers the phase-controlled NRZ differential signals NRZ DATA and NRZ D̅A̅T̅A̅ and the clock signal to the signal mixing terminal 230.

The signal mixing terminal 230 turns on and off the TG switch 234 according to the NRZ differential signals NRZ DATA and NRZ D̅A̅T̅A̅ transferred from the input terminal 210 to switch the clock signal, thereby electrically mixing the two input signals. In detail, the first and second inverters 231 and 232 receive the NRZ differential signals NRZ DATA and NRZ D̅A̅T̅A̅, controls the NRZ differential signals NRZ DATA and NRZ D̅A̅T̅A̅ to have the same phase, and outputs the controlled NRZ differential signals NRZ DATA and NRZ D̅A̅T̅A̅. The third inverter 233 receives the clock signal transferred from the input terminal 210 and executes a push-pull function of the clock signal.

As described above, the NRZ differential signals NRZ DATA and NRZ D̅A̅T̅A̅ and the clock signal passing through the first to third inverters 231 to 233 are inputted to the TG switch 234. As described above with reference to FIG. 5, the TG switch 234 is formed of the first and second pairs of NMOS and PMOS transistors Q1, Q2, Q3, and Q4. When the NRZ differential signals NRZ DATA and NRZ D̅A̅T̅A̅ are applied to the gates of the first pair of NMOS and PMOS transistors Q1 and Q2, the first pair of NMOS and PMOS transistors Q1 and Q2 are turned on and off according to the NRZ differential signals NRZ DATA and NRZ D̅A̅T̅A̅ and output one of the clock signal outputted from the third inverter 233 and signal “0”. In detail, when the NRZ signal is “0”, the first pair of NMOS and PMOS transistors Q1 and Q2 is turned on and outputs the clock signal. When the NRZ signal is “1”, the first pair of NMOS and PMOS transistors Q1 and Q2 is turned off and outputs signal “0” regardless of the clock signal. The output signal of the first pair of NMOS and PMOS transistors Q1 and Q2 is transferred to the fourth inverter 235 via the second pair of NMOS and PMOS transistors Q3 and Q4 always turned on.

As described above, the signal outputted from the TG switch 234 is outputted to the output terminal 250 via the fourth inverter 235. The fourth inverter 235 provides an output load with respect to the clock signal and an input bias of the output terminal 250.

The output terminal 250 is connected to a rear end of the signal mixing terminal 230 and provides a signal interface with the external circuit unit and additional amplitude gains with respect to an output signal.

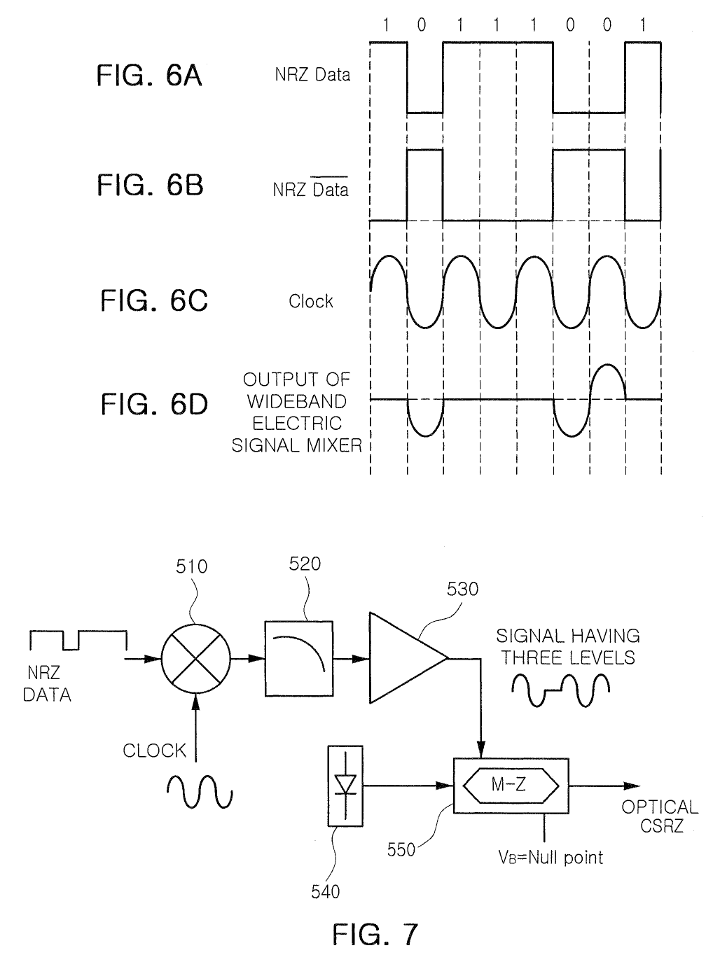

FIGS. 6A to 6D are diagrams illustrating waveforms of signals of the wideband electric signal mixer.

Referring to FIGS. 6A to 6D, when to mix an NRZ signal as shown in FIG. 6A with a clock signal as shown in FIG. 6C, an NRZ data signal NRZ DATA as shown in FIG. 6A, an inverse NRZ data signal NRZ D̅A̅T̅A̅ having a difference of 180 degrees in a phase from the NRZ data signal NRZ DATA, which is shown in FIG. 6B, and a clock signal shown in FIG. 6C are inputted to the signal mixing terminal 230 via the input terminal 210. An output signal mixed in the signal mixing terminal 230 and outputted to the output terminal 250 is shown as in FIG. 6D.

That is, when the NRZ data signal is “1”, “0” is outputted regardless of the clock signal. When the NRZ signal is “0”, the clock signal at a corresponding point in time is outputted as it is. Accordingly, as shown in FIG. 6D, the outputted signal has three levels such as −1, 0, and +1.

Accordingly, the wideband electric signal mixer may convert the NRZ data signal into a desired electric signal having three levels.

As described above, the wideband electric signal mixer may convert the NRZ data into the signal having three levels by mixing the NRZ data and the clock signal. Using the wideband electric signal mixer, an optical transmitter using one of a CSRZ or RZ modulation method may be embodied.

FIG. 7 is a diagram illustrating an optical transmitter according to an exemplary embodiment of the present invention, the optical transmitter employing the CSRZ modulation method.

The CSRZ modulation method is strong in nonlinear characteristics of optical fibers and suitable for a high speed long distance transmission system, which is currently generally used in an optical transmission system.

Referring to FIG. 7, the optical transmitter employing the CSRZ modulation method includes a wideband electric signal mixer 510, a low-pass filter 520, an amplifier 530, a light source 540, and a Mach-Zehnder modulator 550.

The wideband electric signal mixer 510 has the same configuration and operation as the wideband electric signal mixer of FIG. 3 to 5. The wideband electric signal mixer 510 mixes an NRZ data signal with a clock signal having a frequency of ½ of a data transmission rate of the NRZ data signal to convert into a data signal having three levels. The configuration and operation of the wideband electric signal mixer 510 may be known from the description with reference to FIGS. 3 to 5.

The low-pass filter 520 allows a mixed signal having three levels outputted from the wideband electric signal mixer 510 to low pass, thereby reducing a width of an optical spectrum modulated due to a bandwidth limitation effect.

The amplifier 530 amplifies the mixed signal having three levels passing through the low-pass filter 520 and provides the amplified mixed signal as a signal for driving the Mach-Zehnder modulator 550.

The Mach-Zehnder modulator 550 operates while setting a bias voltage on a null point of a transfer characteristic curve, switches a continuous light outputted from the light source 540 according to the mixed signal having three levels, which has the frequency of ½ of the data transmission rate, and converts into an optical signal of the CSRZ modulation method.

The operation of the optical transmitter configured as described above is performed as follows.

A data signal of the NRZ modulation method, which is to be transmitted, and a clock signal having a frequency of ½ of a data transmission rate are inputted to the wideband electric signal mixer 510.

As described above, the NRZ data signal and the clock signal are mixed in the wideband electric signal mixer 510 and converted into an electric signal having a frequency of ½ of the data transmission rate and three levels, which is appropriately limited on a band and amplified while passing through the low-pass filter 520 and the amplifier 530 and applied to the Mach-Zehnder modulator 550.

In this case, a bias voltage of the Mach-Zehnder modulator 550 is set on a null point of a transfer characteristic curve and modulates a continuous light emitted from the light source 540 according to an output signal of the amplifier 530. In this case, since the output signal of the amplifier 530 is the signal having three levels, which has the frequency of ½ of the data transmission rate generated by the wideband electric signal mixer 510, the outputted optical signal is a CSRZ signal.

In the present embodiment, the optical transmitter employing CSRZ modulation method has been described. However, the present invention will not be limited thereto. The wideband electric signal mixer may be applied to various apparatuses.

For example, the wideband electric signal mixer according to an exemplary embodiment of the present invention may be applied to an optical transmitter employing the RZ modulation method. In this case, there is a difference only in a frequency of the clock signal and operation of a Mach-Zehnder modulator.

While the present invention has been shown and described in connection with the exemplary embodiments, it will be apparent to those skilled in the art that modifications and variations can be made without departing from the spirit and scope of the invention as defined by the appended claims.

What is claimed is:

1. A wideband electric signal mixer comprising:
an input terminal controlling an input interface and a phase of a differential signal of a first electric signal and a second electric signal, having a wideband spectrum;
a signal mixing terminal comprising a transmission gate switch receiving and outputting the second electric signal and mixing the first electric signal with the second electric signal by turning the transmission gate switch on and off using the differential signal of the first electric signal passing through the input terminal; and
an output terminal providing an output interface between a mixing signal outputted from the signal mixing terminal and an external circuit unit and amplification function of the mixing signal.

2. The mixer of claim 1, wherein the first electric signal is a non return-to-zero (NRZ) data signal, and
the second electric signal is a clock signal with a certain frequency.

3. The mixer of claim 1, wherein the signal mixing terminal comprises:
first and second inverters receiving the differential signals of the first electric signal, respectively, and controlling the differential signals to have the same phase;
a third inverter receiving the clock signal and executing a push-pull function of the clock signal;
the transmission gate switch turned on and off by the differential signals of the first and second electric signal transferred from the first and second inverters, outputting the clock signal transferred from the third inverter when turned on, and outputting “0” signal when turned off;
a fourth inverter transferring an output signal of the transmission gate switch to the output terminal.

4. The mixer of claim 3, wherein the transmission gate switch comprises:
a first pair of n-type metal-oxide semiconductor (NMOS) and p-type metal-oxide semiconductor (PMOS) transistors switched on and off according to the differential signal of the first electric signal and outputting an output of the third inverter as it is when switched on; and
a second pair of NMOS and PMOS transistors always switched on and transferring an output signal of the first pair of NMOS and PMOS transistors to the fourth inverter.

5. An optical transmitter comprising:
a wideband electric signal mixer comprising a transmission gate switch transferring a clock signal with a certain frequency, turning the transmission gate switch on and off using a differential signal of a data signal to be transmitted, mixing the clock signal with the data signal to output an electric signal with three levels;
a light source emitting continuous light; and
a Mach-Zehnder modulator driven by the electric signal with three levels outputted from the wideband electric signal mixer and converting the light emitted from the light source into an optical signal.

6. The optical transmitter of claim 5, further comprising a low-pass filter and an amplifier filtering and amplifying the electric with three levels outputted from the wideband electric signal mixer to drive the Mach-Zehnder modulator.

7. The optical transmitter of claim 5, wherein the wideband electric signal mixer comprises:
an input terminal controlling an input interface and a phase of a differential signal of a first electric signal and a second electric signal, having a wideband spectrum;
a signal mixing terminal comprising a transmission gate switch receiving and outputting the second electric signal and mixing the first electric signal with the second electric signal by turning the transmission gate switch on and off using the differential signal of the first electric signal passing through the input terminal; and
an output terminal providing an output interface between a mixing signal outputted from the signal mixing terminal and an external circuit unit and amplification function of the mixing signal.

8. The optical transmitter of claim 7, wherein the signal mixing terminal comprises:
first and second inverters receiving the differential signal of the first electric signal, respectively, and controlling the differential signals to have the same phase;
a third inverter receiving the clock signal and executing a push-pull function of the clock signal;
the transmission gate switch turned on and off by the differential signals of the first and second electric signal transferred from the first and second inverters, outputting the clock signal transferred from the third inverter when turned on, and outputting “0” signal when turned off;
a fourth inverter transferring an output signal of the transmission gate switch to the output terminal.

9. The optical transmitter of claim 8, wherein the transmission gate switch comprises:
a first pair of NMOS and PMOS transistors switched on and off according to the differential signal of the first electric signal and outputting an output of the third inverter as it is when switched on; and
a second pair of NMOS and PMOS transistors always switched on and transferring an output signal of the first pair of NMOS and PMOS transistors to the fourth inverter.

10. The optical transmitter of claim 5, wherein the data signal to be transmitted is an NRZ data signal.

11. The optical transmitter of claim 10, wherein the clock signal has a frequency of ½ of a data transmission rate.
